(19) United States
(12) Patent Application Publication
(10) Pub. No.: US 2004/0045987 A1
(43) Pub. Date: Mar. 11, 2004

(54) Corner trowel system

(76) Inventor: Jeff W. Sandau, Tripp, SD (US)

Correspondence Address: Michael S. Neustel, Suite No. 4, 2534 South University Drive, Fargo, ND, 58103, US

(21) Appl. No.: 10/241,539

(22) Filed: Sep. 9, 2002

(51) Int. Cl. B67D 5/42

(52) U.S. Cl. 222/391

(57) ABSTRACT

A corner trowel system for efficiently applying joint compound within an inside corner. The corner trowel system includes a trowel member have a syncline shape, a first port and a second port within opposing sides of the trowel member, a cross tube fluidly connected to the ports, an applicator unit, and a reservoir positioned within the applicator unit. The reservoir is fluidly connected to the cross tube via a delivery tube. The joint compound is dispersed through the ports and then smoothed by the trowel member within an inner corner of a wall.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to joint compound applicators and more specifically it relates to a corner trowel system for efficiently applying joint compound within an inside corner.

2. Description of the Related Art

Joint compound applicators have been in use for years. Conventional joint compound applicators are typically comprised of a hand-operated trowel device for applying the joint compound to a joint such as an inner corner of where two sheets of sheetrock meet at an angle.

The main problem with conventional trowels is that they are labor intensive to utilize. A further problem with conventional trowels is that they are not efficient when working in difficult to reach areas such as inside corners of a wall.

Examples of patented devices which may be related to the present invention include U.S. Pat. No. 2,288,987 to Allen; U.S. Pat. No. 4,358,337 to Johnson et al.; U.S. Pat. No. 4,652,331 to Plasencia; U.S. Pat. No. 2,815,142 to Ames; U.S. Pat. No. 5,545,287 to Carlson; U.S. Pat. No. 5,902,451 to O'Mara et al.; U.S. Pat. No. 5,013,389 to Retti; U.S. Pat. No. 4,597,821 to Munro; and U.S. Pat. No. 3,260,638 to Hoveland.

While these devices may be suitable for the particular purpose to which they address, they are not as suitable for efficiently applying joint compound within an inside corner. Conventional trowels do not provide for efficient application of joint compound to an inside corner of a wall structure.

In these respects, the corner trowel system according to the present invention substantially departs from the conventional concepts and designs of the prior art, and in so doing provides an apparatus primarily developed for the purpose of efficiently applying joint compound within an inside corner.

### BRIEF SUMMARY OF THE INVENTION

In view of the foregoing disadvantages inherent in the known types of trowels now present in the prior art, the present invention provides a new corner trowel system construction wherein the same can be utilized for efficiently applying joint compound within an inside corner.

The general purpose of the present invention, which will be described subsequently in greater detail, is to provide a new corner trowel system that has many of the advantages of the trowels mentioned heretofore and many novel features that result in a new corner trowel system which is not anticipated, rendered obvious, suggested, or even implied by any of the prior art trowels, either alone or in any combination thereof.

To attain this, the present invention generally comprises a trowel member have a syncline shape, a first port and a second port within opposing sides of the trowel member, a cross tube fluidly connected to the ports, an applicator unit, and a reservoir positioned within the applicator unit. The reservoir is fluidly connected to the cross tube via a delivery tube. The joint compound is dispersed through the ports and then smoothed by the trowel member within an inner corner of a wall.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a corner trowel system that will overcome the shortcomings of the prior art devices.

A second object is to provide a corner trowel system for efficiently applying joint compound within an inside corner.

Another object is to provide a corner trowel system that may be utilized within inside corners have various angles such as but not limited to 90 degrees and 45 degrees.

An additional object is to provide a corner trowel system that may apply various types of joint compounds including plaster.

A further object is to provide a corner trowel system that reduces the amount of time to apply joint compound to an inside corner.

Another object is to provide a corner trowel system that simultaneously applies and smoothes the joint compound.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a front upper perspective view of the present invention.

FIG. 2 is a rear perspective view of the present invention.

FIG. 3 is a front view of the present invention.

FIG. 4 is an exploded side perspective view of the present invention.

FIG. 5 is a side cutaway view of the present invention.

FIG. 6 is a rear perspective view of the present invention applying joint compound to an inner corner.

FIG. 7 is a top view of the present invention applying joint compound to an inner corner.

FIG. 8 a top cutaway view of the applicator applying joint compound to an inner corner.

### DETAILED DESCRIPTION OF THE INVENTION

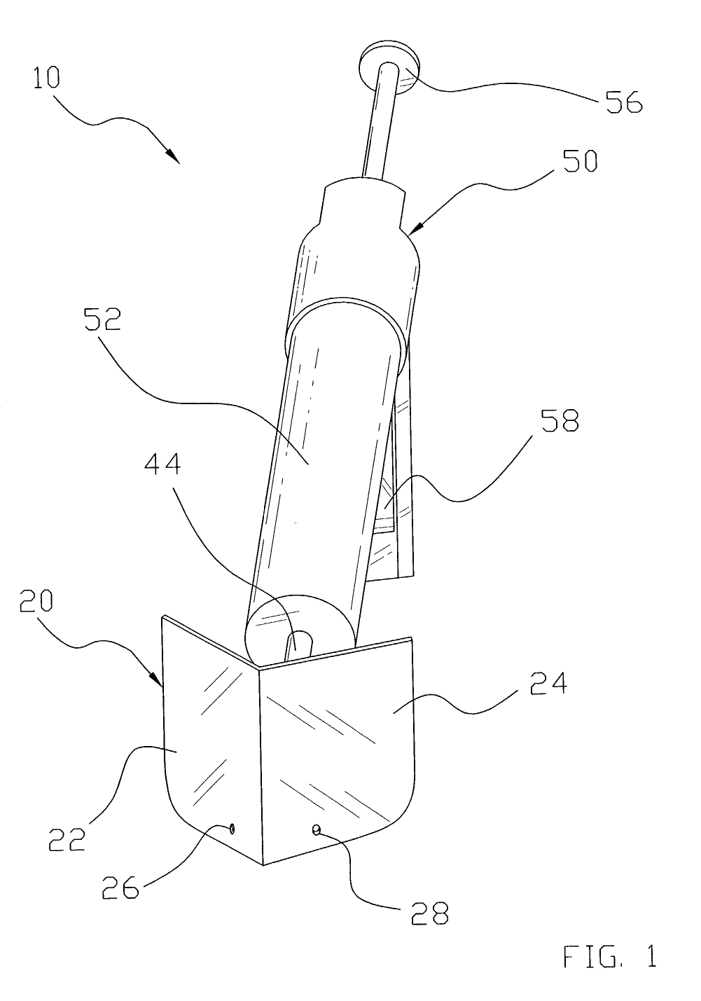

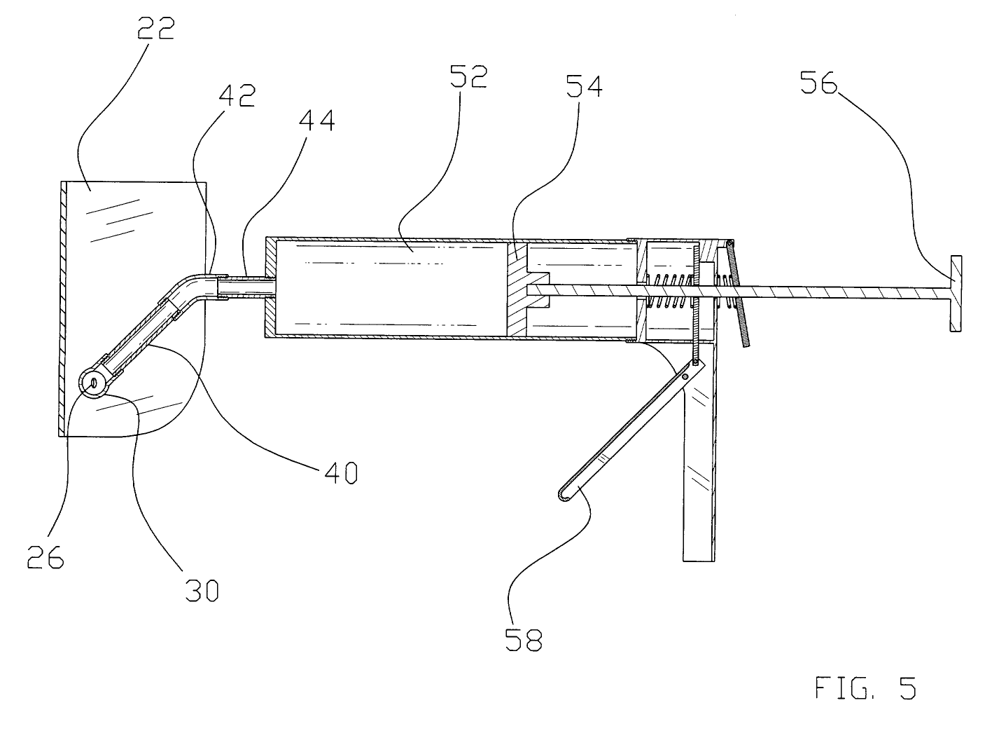

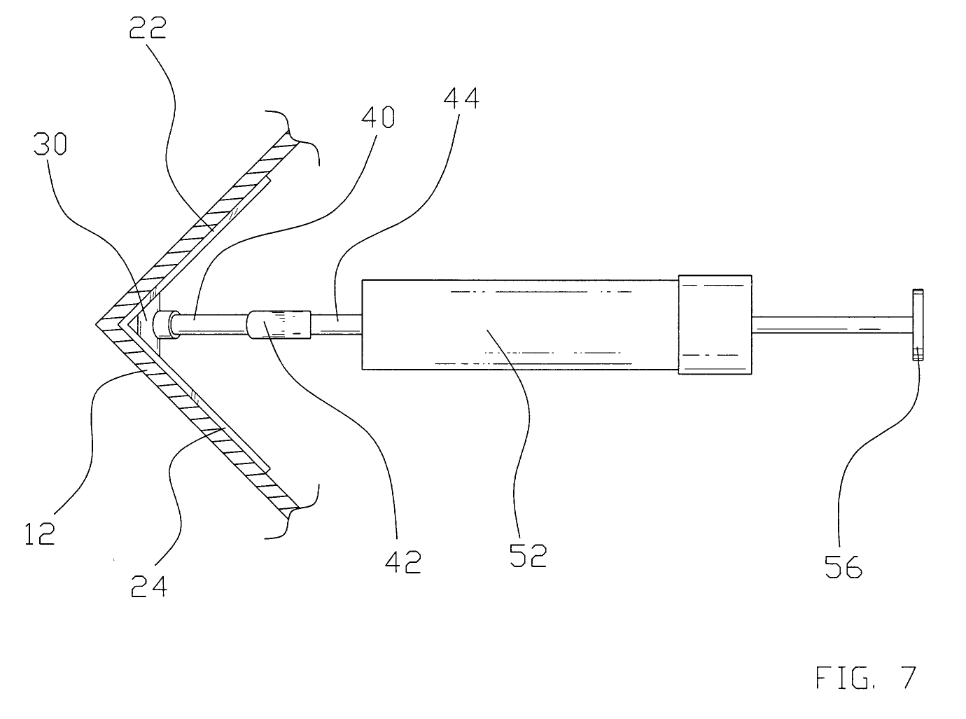

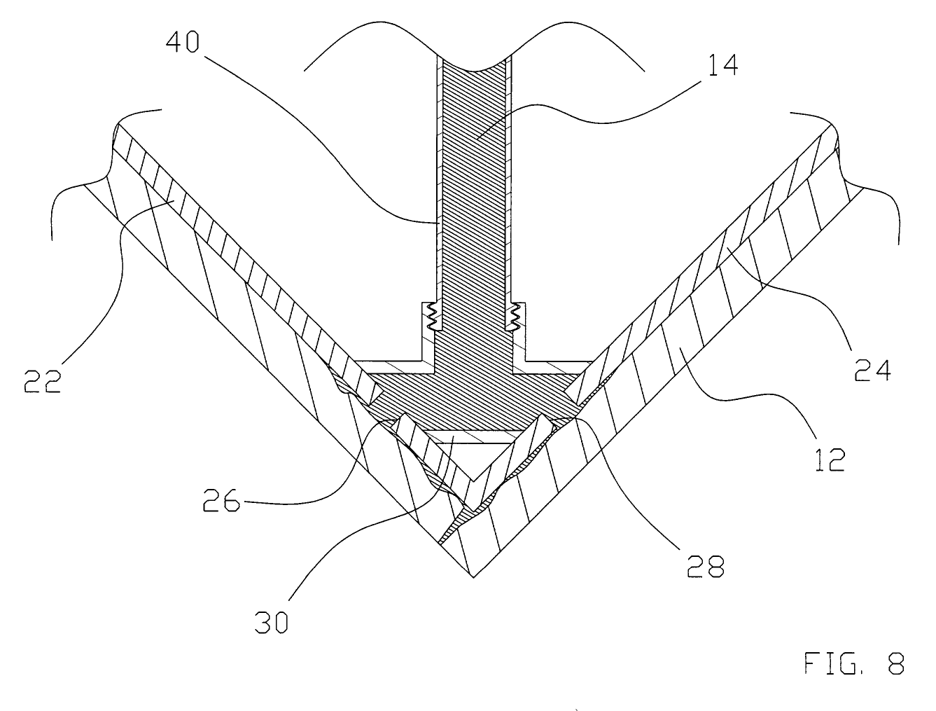

Turning now descriptively to the drawings, in which similar reference characters denote similar elements throughout the several views, FIGS. 1 through 8 illustrate a corner trowel system 10, which comprises a trowel member 20 have a syncline shape, a first port 26 and a second port 28 within opposing sides of the trowel member 20, a cross tube 30 fluidly connected to the ports 26, 28, an applicator unit 50, and a reservoir 52 positioned within the applicator unit 50. The reservoir 52 is fluidly connected to the cross tube 30 via a delivery tube 40. The joint compound 14 is dispersed through the ports 26, 28 and then smoothed by the trowel member 20 within an inner corner of a wall 12.

As shown in FIGS. 1 through 4 of the drawings, the trowel member 20 is comprised of a first member 22 and a second member 24 connected to one another at a desired angle reflecting the angle of the inner corner to apply joint compound 14 upon. The first member 22 and the second member 24 each preferably have a flat and straight outer surface that smoothes the dispensed joint compound 14 within the inner corner of the wall 12.

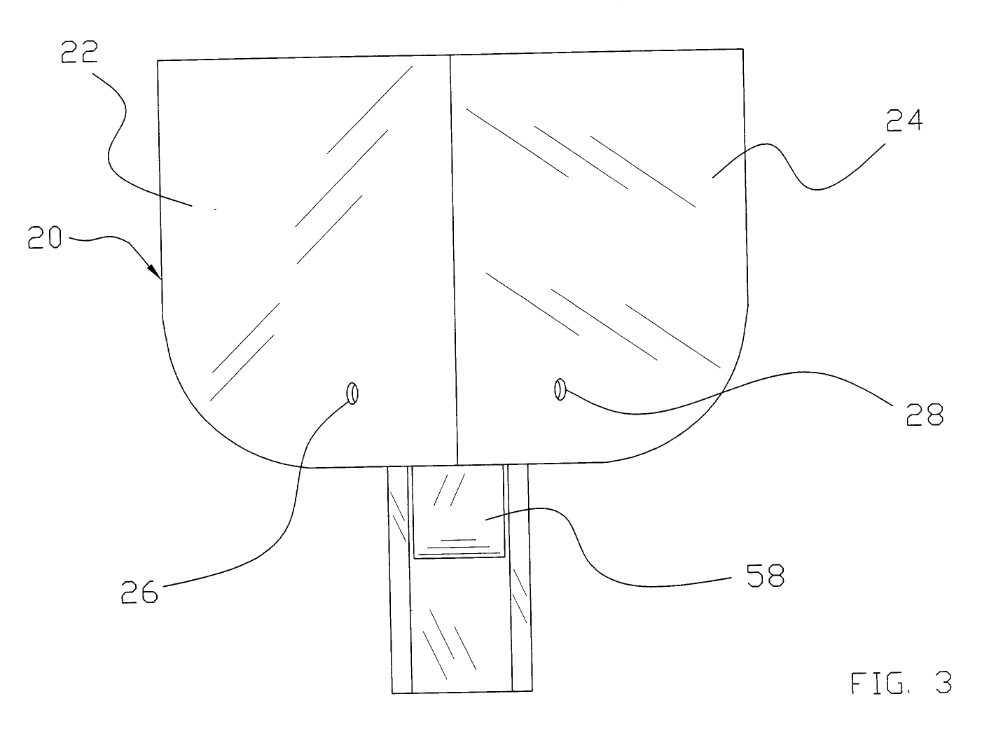

The first member 22 and the second member 24 preferably have mirrored structures as best illustrated in FIG. 3 of the drawings. The outer lower corners of the first member 22 and the second member 24 are preferably rounded to avoid engagement of the wall 12 or other objects as shown in FIG. 1 of the drawings. The angle between the first member 22 and the second member 24 is preferably ninety-degrees, however various other angles may be utilized to construct the trowel member 20. The trowel member 20 may be comprised of various types of materials having various types of physical characteristics such as but not limited to metal or plastic.

FIG. 3 best illustrates the first port 26 within the first member 22 and the second port 28 within the second member 24 for dispensing the joint compound 14 from. The ports 26, 28 are preferably positioned within an inner lower portion of the trowel as further shown in FIGS. 1 and 3 of the drawings. The lower location of the ports 26, 28 allows for adequate surface coverage of the trowel member 20 to ensure that the dispensed joint compound 14 is adequately smoothed upon the wall 12. More than one port 26, 28 may be utilized upon the first member 22 and the second member 24 in various locations. The ports 26, 28 may have various sizes and shapes capable of dispensing the joint compound 14.

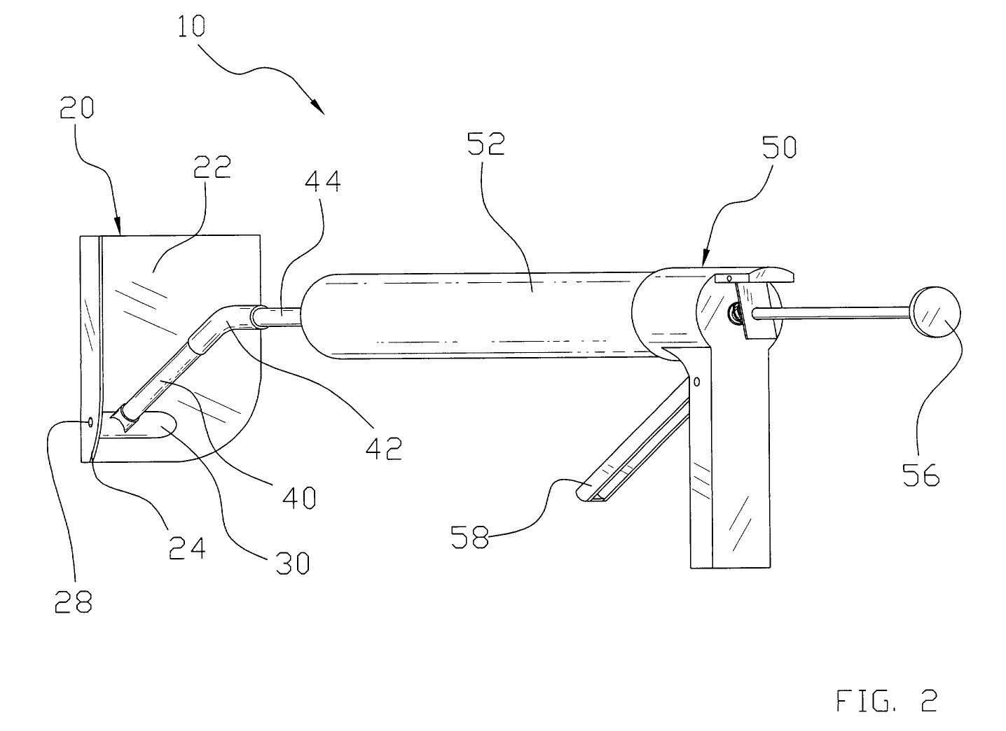

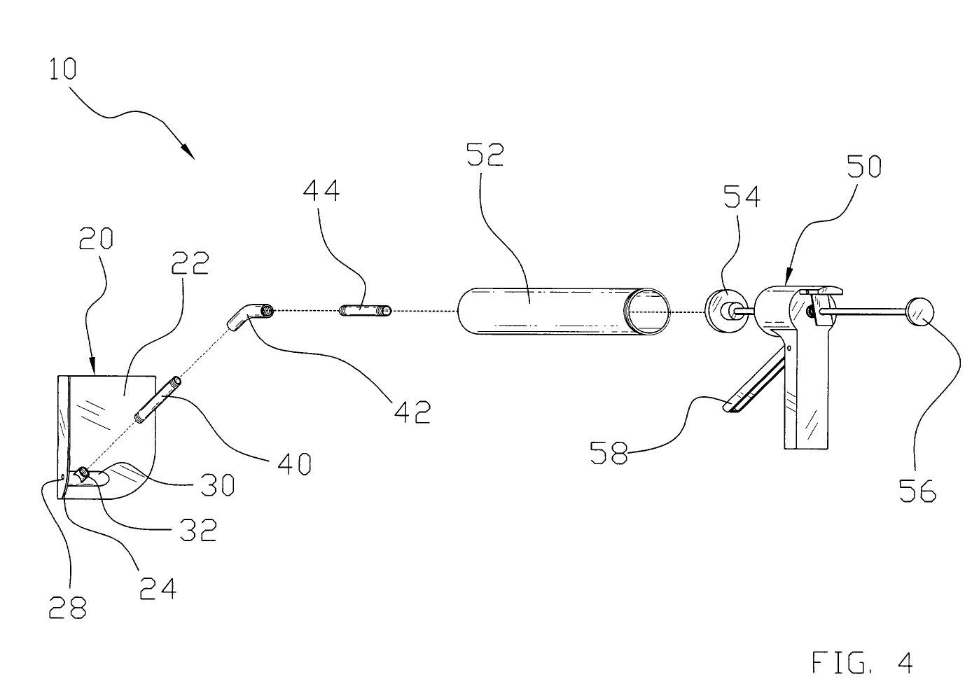

As best illustrated in FIGS. 2, 4, 7 and 8 of the drawings, a cross tube 30 extends between the ports 26, 28 in a fluidly connected manner. The cross tube 30 is fluidly connected to the reservoir 52 containing the joint compound 14 via a delivery tube 40 or other suitable distribution structure. The delivery tube 40 is fluidly connected to the cross tube 30 preferably in a central location for providing even division of the joint compound 14 to the first port 26 and the second port 28. FIGS. 2 and 4 illustrate a corner tube 42 connected to the delivery tube 40 opposite of the cross tube 30 with an inner tube 44 connected to the corner tube 42 for allowing adjustment of the position of the trowel member 20 with respect to the reservoir 52 and the applicator unit 50. The inner tube 44 is threadably connected to the reservoir 52 for receiving the joint compound 14.

The reservoir 52 is comprised of a tubular structure capable of storing a volume of joint compound 14. The reservoir 52 is preferably threadably connected to the applicator unit 50, however various other connection configurations may be utilized which are commonly utilized within caulking guns and similar dispensing devices. The applicator unit 50 has a handle, a plunger 54 attached to a shaft member 56, and a trigger 58 mechanically connected to the shaft member 56 for driving the plunger 54 into the reservoir 52 for dispensing the joint compound 14 from within the reservoir 52.

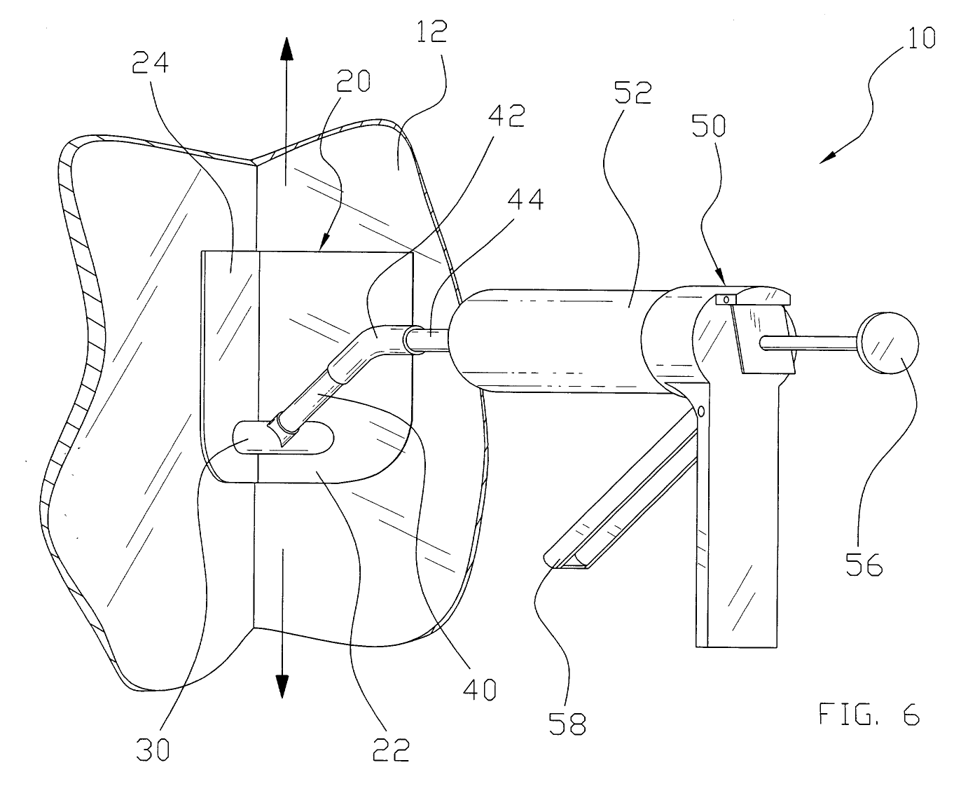

In use, the user positions the desired reservoir 52 within the applicator unit 50 and then fluidly connected the trowel member 20 to the reservoir 52. The user then manipulates the trigger 58 thereby forcing the plunger 54 forwardly into the reservoir 52 thereby forcing the joint compound 14 through the cross tube 30 to the ports 26, 28. As the joint compound 14 is dispensed from the ports 26, 28, the user moves the trowel member 20 along the inside corner of the wall 12 thereby dispensing and smoothing the joint compound 14 within the inside corner as shown in FIGS. 6, 7 and 8 of the drawings. This process continues until the reservoir 52 is emptied or the inside corner is properly filled.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for Corner Trowel System
□ ENVIRONMENTAL ELEMENTS
□
□
□
□
□
□
□
□
□
□ 10. Corner Trowel System
□ 11.
□ 12. Wall
□ 13.
□ 14. Joint Compound
□ 15.
□ 16.
□ 17.
□ 18.
□ 19.
□ 20. Trowel Member
□ 21.
□ 22. First Member
□ 23.
□ 24. Second Member
□ 25.
□ 26. First Port
□ 27.
□ 28. Second Port
□ 29.
□ 30. Cross Tube
□ 31.
□ 32.
□ 33.
□ 34.
□ 35.
□ 36.
□ 37.
□ 38.
□ 39.
□ 40. Delivery Tube
□ 41.
□ 42. Corner Tube
□ 43.
□ 44. Inner Tube
□ 45.
□ 46.
□ 47.
□ 48.
□ 49.
□ 50. Applicator Unit
□ 51.
□ 52. Reservoir
□ 53.
□ 54. Plunger
□ 55.
□ 56. Shaft Member
□ 57.
□ 58. Trigger
□ 59.
□ 60.
□ 61.
□ 62.
□ 63.
□ 64.
□ 65.
□ 66.
□ 67.
□ 68.
□ 69.
□ 70.
□ 71.
□ 72.
□ 73.
□ 74.
□ 75.
□ 76.
□ 77.
□ 78.
□ 79.

I claim:

1. A corner trowel system, comprising:
a trowel member having a first member and a second member, wherein said first member and said second member are connected at an angle forming a syncline structure;
a first port within said first member;
a second port within said second member;
a cross tube fluidly connected between said first port and said second port;
an applicator unit and a reservoir retaining a volume of joint compound; and
a delivery tube fluidly connected between said reservoir and said cross tube.

2. The corner trowel system of claim 1, wherein said first port and said second port are positioned within a lower portion of said trowel member.

3. The corner trowel system of claim 2, wherein said first port and said second port are positioned within an inner portion of said trowel member.

4. The corner trowel system of claim 1, wherein said first port and said second port are positioned within an inner portion of said trowel member.

5. The corner trowel system of claim 1, wherein said first member is approximately 90 degrees with respect to said second member.

6. The corner trowel system of claim 1, wherein an outer surface of said trowel is flat.

7. The corner trowel system of claim 1, including a corner tube fluidly positioned between said delivery tube and said reservoir.

8. The corner trowel system of claim 7, including an inner tube fluidly positioned between said corner tube and said reservoir.

9. The corner trowel system of claim 1, wherein opposing lower corners of said trowel member are rounded.

10. The corner trowel system of claim 1, wherein said reservoir is comprised of a tubular structure and wherein said applicator unit includes a plunger extendable into said reservoir for dispensing said joint compound.

11. A corner trowel system, comprising:
a trowel member having a first member and a second member, wherein said first member and said second member are connected at an angle forming a syncline structure;
a first port within said first member;
a second port within said second member;
an applicator unit and a reservoir retaining a volume of joint compound; and
a delivery tube fluidly connected said first port and said second port.

12. The corner trowel system of claim 11, wherein said first port and said second port are positioned within a lower portion of said trowel member.

13. The corner trowel system of claim 12, wherein said first port and said second port are positioned within an inner portion of said trowel member.

14. The corner trowel system of claim 11, wherein said first port and said second port are positioned within an inner portion of said trowel member.

15. The corner trowel system of claim 11, wherein said first member is approximately 90 degrees with respect to said second member.

16. The corner trowel system of claim 11, wherein an outer surface of said trowel is flat.

17. The corner trowel system of claim 11, including a corner tube fluidly positioned between said delivery tube and said reservoir.

18. The corner trowel system of claim 17, including an inner tube fluidly positioned between said corner tube and said reservoir.

19. The corner trowel system of claim 11, wherein opposing lower corners of said trowel member are rounded.

20. The corner trowel system of claim 11, wherein said reservoir is comprised of a tubular structure and wherein said applicator unit includes a plunger extendable into said reservoir for dispensing said joint compound.
